(19) United States
(12) Patent Application Publication
(10) Pub. No.: US 2008/0277043 A1
(43) Pub. Date: Nov. 13, 2008

(54) METHOD OF ADJUSTING FIRING PROFILE OF ALUMINA MATERIAL AND METHOD OF MANUFACTURING CERAMIC STACK BODY

(75) Inventors: Eturo Yasuda, Okazaki-shi (JP); Daisuke Makino, Ichinomiya-shi (JP); Akio Tanaka, Gifu-shi (JP); Hirokatsu Mukai, Kuwana-shi (JP)

Correspondence Address: NIXON & VANDERHYE, PC, 901 NORTH GLEBE ROAD, 11TH FLOOR, ARLINGTON, VA, 22203, US

(73) Assignees: NIPPON SOKEN, INC, Nishio-city (JP); DENSO CORPORATION, Kariya-city (JP)

(21) Appl. No.: 12/111,441

(22) Filed: Apr. 29, 2008

(30) Foreign Application Priority Data
May 8, 2007 (JP) 2007-123637

(51) Int. Cl. C03B 29/00

(52) U.S. Cl. 156/89.11

(57) ABSTRACT

A method of matching a firing profile of alumina material is disclosed as having a reference profile preparing step of preparing a reference profile of dissimilar material, an alumina profile preparing step of preparing an alumina profile of alumina material, a comparing step of comparing the reference profile and the alumina profile to determine whether to or not to perform correction on the alumina profile, and an adjusting step of adjusting the alumina material by increasing or decreasing a specific surface area of alumina raw material powder or by adding zirconia or magnesia to alumina material when a determination is made that the alumina profile needs to be corrected.

### CROSS REFERENCE TO RELATED APPLICATIONS

This application is related to Japanese Patent Application No. 2007-123637, filed on May 8, 2007, the content of which is hereby incorporated by reference.

### BACKGROUND OF THE INVENTION

1. Technical Field of the Invention

The present invention relates to a method of matching a firing profile of alumina material having a principal component of alumina raw material powder and a method of manufacturing a ceramic stack body using such a firing profile adjusting method.

2. Description of the Related Art

Research and development work has heretofore been made in the art to provide an air/fuel ratio sensor and a nitrogen oxide sensor or the like as a gas sensor for use in a motor vehicle or the like to detect and measure gas components in exhaust gases emitted from the internal combustion engine of a motor vehicle (see Japanese Patent Application Publication No. 2002-181764).

The gas sensor normally incorporates a gas sensing element, which includes a ceramic stack body composed of a stack of plural layers usually made of ceramic materials such as alumina or zirconia or the like.

When manufacturing the ceramic stack body forming the gas sensing element, ceramic sheets forming respective layers are typically stacked and bonded to each other by thermocompression bonding or adhesive to form a unitary structure, which in turn is fired to provide the ceramic stack body (see Japanese Patent Application Publication No. 2002-340843).

With such a manufacturing method described above, the respective ceramic sheets have firing contraction rates with different behaviors (firing profiles). In this case, an issue arises with warping or flaking occurring in the ceramic sheets. This results in degradation in dimensional precision and quality of the ceramic stack body.

In order to suppress the occurrence of warping or flaking of the ceramic sheets during firing, an attempt has been made to provide a method of firing stacked ceramic sheets with a heavy stone placed thereon. However, since this attempt to minimize the occurrence of warping or flaking of the ceramic sheets occurs under a loaded condition, residual stresses occur in the ceramic sheets, causing the possibility of cracks occurring in internal areas of the ceramic sheets.

Further, although there is a method of matching firing profiles of the respective ceramic sheets to each other for minimizing the occurrence of warping or flaking during the firing steps, such a matching method cannot be applied to a case wherein respective layers are made of dissimilar materials.

Accordingly, with the gas sensing element, if an attempt is made to match the firing profile of alumina, constituting a main component of the material, to the firing profile of another material, the issue can be addressed in an effective manner. However, methods of matching the firing profiles of dissimilar materials still remains inadequate.

### SUMMARY OF THE INVENTION

The present invention has been completed with a view to addressing the above issues and has an object to provide a method of matching the firing profile of alumina material that enables the firing profile of alumina material to match the firing profile of dissimilar material with high precision and a method of manufacturing a ceramic stack body using such a firing profile adjusting method.

To achieve the above object, a first aspect of the present invention provides a method of adjusting the firing profile of alumina material for matching the firing profile of alumina material to the firing profile of dissimilar material using a firing profile representing the behavior of the firing contraction rate in a firing step by referring to the relationship between firing temperature and firing contraction rate, the method comprising: a reference profile preparing step of preparing a reference profile representing the firing profile of the dissimilar material occurring when the dissimilar material is fired under a specified firing condition; an alumina profile preparing step of preparing an alumina profile representing the firing profile of the alumina material occurring when the alumina material is fired under the specified firing condition; a comparing step of making a comparison between the reference profile and the alumina profile for determining whether to correct the alumina profile so as to lower or increase as appropriate the contraction rate in an early-stage sintering region; and an adjusting step of adjusting the alumina material by increasing or decreasing the specific surface area of the alumina raw material powder when a determination is made in the comparing step that the alumina profile needs to be corrected so as to increase the contraction rate in the early-stage sintering region.

As set forth above, the method of matching the firing profile of the alumina material according to the first aspect of the present invention relates to a method of matching the firing profile (alumina profile) of the alumina material to the firing profile (reference profile) of the dissimilar material and, more particularly, to a method of correcting the alumina profile in the early-stage sintering region.

More particularly, the reference profile preparing step and the alumina profile preparing step are conducted for preparing the reference profile and the alumina profile, respectively. Then, the comparing step is conducted to make the comparison between the reference profile and the alumina profile, thereby making a determination whether to correct the alumina profile. When the determination is made that the alumina profile needs to be corrected, the adjusting step is conducted for adjusting the alumina material. This allows the alumina profile to match the reference profile.

According to the first aspect of the present invention, the adjusting step is conducted to adjust the alumina material. That is, when correcting the alumina profile to lower the contraction rate in the early-stage sintering region, an attempt is made to increase the specific surface area of the alumina raw material powder. In contrast, when correcting the alumina profile in the early-stage sintering region to increase the contraction rate, another attempt is made to lower the specific surface area of the alumina raw material powder.

It has been known that with ceramic raw material powder such as alumina (Al₂O₃) or the like, firing behavior varies depending on the specific surface area. In general, as the specific surface area increases, the sintering is accelerated and, in contrast, as the specific surface area decreases, the sintering is retarded. The first aspect of the present invention utilizes such a phenomenon and makes it possible to retard the sintering (contraction) of the alumina material in the early-stage sintering region upon increasing the specific surface area of the alumina raw material powder and correct the alumina profile so as to lower the contraction rate. In addition, decreasing the specific surface area of the alumina raw material powder results in a capability of accelerating the sintering (contraction) of the alumina material in the early-stage sintering region and correcting the alumina profile so as to increase the contraction rate.

Thus, by varying the specific surface area of the alumina raw material powder forming the principal component of the alumina material, it becomes possible to finely control the alumina profile in the early-stage sintering region. This enables the alumina profile to be easily matched to the reference profile with increased precision. That is, this makes it possible to easily match the firing profile of the alumina material to the firing profile of the dissimilar material with high precision.

A second aspect of the present invention provides a method of adjusting the firing profile of alumina material to the firing profile of dissimilar material using the firing profile representing the behavior of firing contraction rate in the firing step by referring to the relationship between firing temperature and firing contraction rate, the method comprising: a reference profile preparing step of preparing a reference profile representing the firing profile of the dissimilar material occurring when the dissimilar material is fired under a specified firing condition; an alumina profile preparing step of preparing an alumina profile representing the firing profile of the alumina material occurring when the alumina material is fired under the specified firing condition; a comparing step of making a comparison between the reference profile and the alumina profile for determining whether to or not to correct the alumina profile so as to lower the contraction rate in a middle-stage sintering region; and an adjusting step of adjusting the alumina material by adding zirconia to the alumina material when a determination is made in the comparing step that the alumina profile needs to be corrected so as to lower the contraction rate in the middle-stage sintering region.

As set forth above, the method of adjusting the firing profile of the alumina material according to the second aspect of the present invention relates to the method of adjusting the firing profile (alumina profile) of the alumina material to the firing profile (reference profile) of the dissimilar material and, more particularly, to the method of correcting the alumina profile to lower the contraction rate in the middle-stage sintering region.

In addition, the second aspect of the present invention includes the same basic steps as those of the first aspect of the present invention.

According to the second aspect of the present invention, the adjusting step is conducted to adjust the alumina material. That is, for correcting the alumina profile so as to lower the contraction rate in the middle-stage sintering region, zirconia is added to the alumina material.

When zirconia (ZrO₂) is added to alumina (Al₂O₃), zirconia is present in the middle-stage sintering region with no solution in alumina. Thus, the sintering of alumina particles can be blocked, thereby enabling the sintering to be retarded. The second aspect of the present invention utilizes such a concept and makes it possible to retard the sintering (contraction) of the alumina material in the middle-stage sintering region upon adding zirconia to the alumina material and correct the alumina profile so as to lower the contraction rate.

Thus, by adding zirconia to the alumina material, it becomes possible to finely control the alumina profile in the middle-stage sintering region. This enables the alumina profile to be easily matched to the reference profile with increased precision. That is, this makes it possible to easily match the firing profile of the alumina material to the firing profile of the dissimilar material with high precision.

A third aspect of the present invention provides a method of adjusting the firing profile of alumina material to match the firing profile of alumina material to the firing profile of dissimilar material using the firing profile representing the behavior of the firing contraction rate in the firing step by referring to the relationship between firing temperature and firing contraction rate, the method comprising: a reference profile preparing step of preparing a reference profile representing the firing profile of the dissimilar material occurring when the dissimilar material is fired under a specified firing condition; an alumina profile preparing step of preparing an alumina profile representing the firing profile of the alumina material occurring when the alumina material is fired under the specified firing condition; a comparing step of making a comparison between the reference profile and the alumina profile for determining whether to or not to correct the alumina profile so as to increase the contraction rate in the early-stage sintering region, and an adjusting step of adjusting the alumina material by adding magnesia to the alumina material when a determination is made in the comparing step that the alumina profile needs to be corrected so as to increase the contraction rate in the middle-stage sintering region.

As set forth above, the method of adjusting the firing profile of the alumina material according to the third aspect of the present invention relates to the method of adjusting the firing profile (alumina profile) of the alumina material to the firing profile (reference profile) of the dissimilar material and, more particularly, to the method of correcting the alumina profile to increase the contraction rate in the middle-stage sintering region.

In addition, the third aspect of the present invention includes the same basic steps as those of the first aspect of the present invention.

According to the third aspect of the present invention, the adjusting step is conducted to adjust the alumina material. That is, for correcting the alumina profile so as to increase the contraction rate in the middle-stage sintering region, magnesia is added to the alumina material.

When magnesia (MgO) is added to alumina (Al₂O₃), magnesia is dissolved in alumina in the middle-stage sintering region with spinel particles separated out on the boundary of the alumina particles. This enables the alumina material to be dense and also to suppress abnormal growth of the alumina particles, thereby promoting the sintering of the alumina material. This third aspect of the present invention utilizes such a phenomenon and makes it possible to accelerate the sintering (contraction) of the alumina material in the middle-stage sintering region upon adding magnesia to the alumina material and correct the alumina profile so as to increase the contraction rate.

Thus, by adding magnesia to the alumina material, it becomes possible to finely control the alumina profile in the middle-stage sintering region. This enables the alumina profile to be easily matched to the reference profile with increased precision. That is, this makes it possible to easily match the firing profile of the alumina material to the firing profile of the dissimilar material with high precision.

A fourth aspect of the present invention provides a method of adjusting the firing profile of alumina material to the firing profile of dissimilar material using the firing profile representing the behavior of the firing contraction rate in the firing step by referring to the relationship between firing temperature and firing contraction rate, the method comprising: a reference profile preparing step of preparing a reference profile representing the firing profile of the dissimilar material occurring when the dissimilar material is fired under a specified firing condition; an alumina profile preparing step of preparing an alumina profile representing the firing profile of the alumina material occurring when the alumina material is fired under the specified firing condition; a comparing step of making a comparison between the reference profile and the alumina profile for determining whether to correct the alumina profile so as to decrease or decrease the contraction rate in an early-stage sintering region; and an adjusting step of adjusting the alumina material by increasing the specific surface area of the alumina raw material powder when a determination is made in the comparing step that the alumina profile needs to be corrected so as to lower the contraction rate in the early-stage sintering region and adding magnesia to the alumina material when a determination is made in the comparing step that the alumina profile needs to be corrected so as to increase the contraction rate in the middle-stage sintering region.

As set forth above, the method of adjusting the firing profile of the alumina material according to the fourth aspect of the present invention relates to the method of adjusting the firing profile (alumina profile) of the alumina material to the firing profile (reference profile) of the dissimilar material and, more particularly, to the method of correcting the alumina profile in the early-stage and the middle-stage sintering regions.

In addition, the fourth aspect of the present invention includes the same basic steps as those of the first aspect of the present invention.

According to the fourth aspect of the present invention, the adjusting step is conducted to adjust the alumina material. That is, for correcting the alumina profile so as to lower the contraction rate in the early-stage sintering region, an attempt is made to increase the specific surface area of the alumina raw material powder. In addition, for correcting the alumina profile so as to increase the contraction rate in the early-stage sintering region, an attempt is made to decrease the specific surface area of the alumina raw material powder. Moreover, when correcting the alumina profile so as to lower the contraction rate in the middle-stage sintering region, zirconia is added to alumina raw material powder. In addition, when correcting the alumina profile so as to increase the contraction rate in the middle-stage sintering region, magnesia is added to the alumina raw material powder.

These treatments result in the same effects as those obtained in the first to third aspects of the present invention.

Thus, with the fourth aspect of the present invention, the attempt is made to vary the specific surface area of the alumina raw material powder forming the principal component of the alumina material and to add zirconia or magnesia to the alumina raw material powder. Such treatments enable the alumina profile to be finely controlled in the early-stage or the middle-stage sintering regions. This enables the alumina profile to be easily matched to the reference profile with increased precision. That is, this makes it possible to easily match the firing profile of the alumina material to the firing profile of the dissimilar material with high precision.

A fifth aspect of the present invention provides a method of manufacturing a ceramic stack body having alumina ceramic sheets, made of alumina material having a principal component of alumina raw material powder, and dissimilar ceramic sheets made of dissimilar material, which are stacked and fired in a unitary structure, the method comprising: a firing profile adjusting step of matching the firing profile of the alumina material to the firing profile of the dissimilar material using the method of adjusting the firing profile of the alumina material to the firing profile of the dissimilar alumina material using the method of adjusting the firing profile of alumina material obtained in the first aspect of the present invention; a sheet preparing step of shaping the alumina material to prepare the alumina ceramic sheets and shaping the dissimilar material to prepare the dissimilar ceramic sheets; and a firing step of stacking the alumina ceramic sheets and the dissimilar ceramic sheets into the unitary structure and subsequently firing the unitary structure to prepare the ceramic stack body.

According to the fifth aspect of the present invention, the adjusting step is conducted to match the firing profile of the alumina material to the firing profile of the dissimilar material using the method of matching the firing profile of alumina material obtained in the first aspect of the present invention. Thereafter, in conducting the sheet preparing step, the alumina ceramic sheets and the dissimilar ceramic sheets are prepared using the alumina material and the dissimilar material whose firing profiles are matched to each other in the firing profile preparing step. Then, in the firing step, the alumina ceramic sheets and the dissimilar ceramic sheets are stacked on each other to form a unitary structure, after which the unitary structure is fired thereby producing the ceramic stack body.

Thus, the sheet preparing step enables the alumina ceramic sheets and the dissimilar ceramic sheets to be manufactured with the respective firing profiles becoming closer to each other. Therefore, with the alumina ceramic sheets and the dissimilar ceramic sheets stacked on each other into the unitary structure which is subsequently fired, both the alumina ceramic sheets and the dissimilar ceramic sheets have the firing profiles matching more closely to each other. This enables the suppression of the occurrence of defects such as warping, flaking or cracks of the ceramic sheets during the firing step. Thus, the ceramic stack body can be obtained with high precision in dimension with increased quality.

With the first and fourth aspects of the present invention, the alumina raw material powder may be preferably manufactured by preparing an intermediate alumina raw material powder upon calcining aluminum hydroxide resulting from Bayer's method or an organic aluminum hydrolysis method, firing the intermediate alumina raw material powder so as to accelerate grain growth in the alpha phase to prepare an alumina raw material powder aggregate, and subsequently pulverizing the alumina raw material aggregate.

In this case, the alumina raw material powder has an average particle diameter and a specific surface area or the like that can be controlled at desired values.

In addition, as used herein, the expression “intermediate alumina raw material powder is fired in the alpha phase” refers to a condition in which a phase transition occurs in a crystal structure of alumina to be converted into α-alumina when fired. That is, this means that the whole of alumina has an increasing ratio of α-alumina.

In manufacturing the alumina raw material powder, further, a calcining temperature of aluminum hydroxide may be preferably 600° C. or less.

Furthermore, a firing temperature of the intermediate alumina raw material powder may preferably fall in a range from 800 to 1200° C.

Moreover, the alumina raw material powder aggregate may be preferably pulverized using a ball mill, a pearl mill or the like.

In the adjusting step, the specific surface area of the alumina raw material powder may preferably depend on the firing temperature of the intermediate alumina raw material powder or/and a pulverizing time interval of the alumina raw material powder aggregate during a production of the alumina raw material powder.

In this case, varying one or both of the firing temperature of the intermediate alumina raw material powder and the pulverizing time interval of the alumina raw material powder aggregate enables the specific surface area of the alumina raw material powder to be easily controlled.

Further, the specific surface area of the alumina raw material powder may be adjusted by adjusting particle diameters of the alumina raw material powder.

There is a correlationship between the specific surface area of the alumina raw material powder and the particle diameters. Therefore, as the particle diameter of the alumina raw material powder decrease, the specific surface area of the alumina raw material powder increases. In contrast, as the particle diameters of the alumina raw material powder increase, the specific surface area of the alumina raw material powder decreases. Accordingly, it becomes possible to easily adjust the specific surface area of the alumina raw material powder with an indication of the particle diameter of the alumina raw material powder.

Further, the specific surface area of the alumina raw material powder may fall in a range from 10 to 13 m²/g and the average particle diameter of the alumina raw material powder may preferably fall in a range from 0.25 to 0.35 μm.

In this case, the alumina raw material powder becomes a powder with superior sintering capability.

With the second and fourth aspects of the present invention, in the adjusting step, the amount of zirconia to be added to the alumina material is selected to lie in a value of 6% by weight or less on the basis of 100% by weight of the alumina raw material powder.

If the amount of zirconia to be added exceeds the value of 6% on the basis of 100% by weight of the alumina raw material powder, it becomes practically impossible to obtain an effect of retarding the sintering of the alumina material in the middle-stage sintering region while adjusting the alumina profile to lower the contraction rate.

With the third and fourth aspects of the present invention, in the adjusting step, the amount of magnesia to be added to the alumina material is selected to lie in a value of 1000 ppm or less relative to the alumina raw material powder.

If the amount of magnesia to be added exceeds the value of 1000 ppm relative to the alumina raw material powder, it becomes practically impossible to obtain an effect of accelerating the sintering of the alumina material in the middle-stage sintering region while adjusting the alumina profile to increase the contraction rate.

With the fourth aspect of the present invention, when the determinations are made in the comparing step that the alumina profile needs to be corrected in both of the early-stage sintering region and the middle-stage sintering region, a correction for the middle-stage sintering region may be preferably executed with priority.

Further, when the determinations are made in the comparing step that the alumina profile needs to be corrected in both of the early-stage sintering region and the middle-stage sintering region, a correction for the early-stage sintering region may be preferably executed before other correction steps.

That is, one of the correction for the early-stage sintering region and the correction for the middle-stage sintering region may be executed first before the other correction step.

With the first to fourth aspects of the present invention, the reference profile preparing step may be preferably conducted after which the alumina profile preparing step, the comparing step and the adjusting step are repeatedly conducted until a determination is made in the comparing step that no need arises to correct the alumina material.

In this case, the firing profile of the alumina material can be matched to the firing profile of the dissimilar material with further increased precision.

Further, the expression “the firing profile of the alumina material is matched to the firing profile of the dissimilar material”, i.e., “the alumina profile is matched to the reference profile” is construed not to mean that the firing profile of the alumina material is strictly matched to the firing profile of the dissimilar material but to mean that the alumina profile and the reference profile exhibit similar behaviors and are closely matched to each other to the extent not to cause a defect when fired in a unitary structure. Under a circumstance where the firing profiles are closer to each other to such an extent, in the comparing step, the determination can be made that the alumina profile has no need to be corrected.

Further, the alumina profile has regions targeted for corrections that include the early-stage sintering region and the middle-stage sintering region. As used herein, the term “early-stage sintering region” refers to a region in the vicinity of, for instance, the range from 1100 to 1200° C. in which the contraction begins to occur in the sintering process of alumina. As used herein, further, the term “middle-stage sintering region” refers to a region in the vicinity of, for instance, the range from 1200 to 1400° C. in which the contraction occurs at the highest rate in the sintering process of alumina.

Moreover, the rest of the regions except for the early-stage sintering region and the middle-stage sintering region, i.e., the region subsequent to the middle-stage sintering region can be regarded to be a final-stage sintering region. As used herein, the term “final-stage sintering region” refers to a region in the vicinity of, for instance, the range from 1400 to 1500° C. in which the contraction is mostly completed in the sintering process of alumina.

Further, the expression “the alumina profile is corrected to lower the contraction rate” is meant by the fact that the alumina profile is shifted in a direction to lower the firing contraction rate in the region to be corrected.

Furthermore, the expression “the alumina profile is corrected to increase the contraction rate” is meant by the fact that the alumina profile is shifted in a direction to increase the firing contraction rate in the region to be corrected.

Moreover, the alumina profile may be corrected in a whole of the region to be corrected or in a part of the region to be corrected.

When a need arises to correct the alumina profile in the final-stage sintering region, this can be achieved by controlling a final firing contraction rate (hereinafter referred to as a “final contraction rate”) of the alumina material.

The final contraction rate remarkably depends on the volume of organic substances that will disappear when fired. Therefore, adjusting the organic-substance volume ratio, contained in the alumina material, in the adjusting step enables the final contraction rate of the alumina material to be controlled. This enables the alumina profile to be corrected in the final-stage sintering region. Thus, it becomes possible to match the alumina profile to the reference profile as closely as possible.

Further, the alumina material may be composed of the principal component of only the alumina raw material powder or may contain organic substances such as a binder, a dispersant, a plasticizer or the like depending on need.

Furthermore, the alumina raw material powder can be manufactured using Bayer's method, organic aluminum hydrolysis method or the like.

Moreover, examples of the dissimilar materials may include a principal component composed of a ceramic raw material powder such as zirconia, titania, perovskite oxide, spinel oxide or the like.

In addition, like the alumina material, the dissimilar material may be composed of a raw material powder forming a principal component and may contain further organic substances such as a binder, a dispersant, a plasticizer or the like depending on needs.

With the fifth aspect of the present invention, the sheet preparing step can be accomplished to form the alumina ceramic sheets and the dissimilar ceramic sheets using a doctor blade method, an extrusion molding method, an injection molding method, a single axis press forming method or the like.

The ceramic stack body may be preferably used as used as a gas sensing element.

In this case, the gas sensing element can exhibit a significant characteristic of the ceramic stack body having increased precision in dimension with high quality. That is, a gas sensor, incorporating such a gas sensing element, has been required to be miniaturized in size in recent years and used under an environment at further increasing temperatures. To meet such requirements, the gas sensor is required to have further increased dimensional precision and durability. Thus, applying the ceramic stack body, having increased precision in dimension with high quality, to the gas sensing element enables a gas sensor to be put into practice with a miniaturized size and excellent durability.

### BRIEF DESCRIPTION OF THE DRAWINGS

FIG. 1 is a block diagram showing a flow chart of various steps for adjusting the firing profile of alumina material carried out in Example 1 of the present invention.

FIG. 2 is a graph showing a reference profile (Z1) and alumina profiles (A11 and A12) in Example 1 of the present invention.

FIG. 3 is a graph showing the relationship between the ratio of organic substance to alumina material and a final contraction rate thereof in Example 1 of the present invention.

FIG. 4 is a graph showing the reference profile (Z1) and alumina profiles (A12 and A13) in Example 1 of the present invention.

FIG. 5 is a graph showing a variation in firing profile when adding zirconia to alumina material in Example 1 of the present invention.

FIG. 6 is a graph showing variations in firing contraction rates of the reference profile (Z1) and alumina profiles (A13 and A14) in Example 1 of the present invention.

FIG. 7 is a graph showing variations in firing contraction rates of various materials when magnesia is added to alumina material in Example 1 of the present invention.

FIG. 8 is a graph showing the reference profile (Z1) and alumina profiles (A14 and A15) in Example 1 of the present invention.

FIG. 9 is a graph showing variations in firing contraction rates of various materials when varying the specific surface area of alumina raw material powder in Example 1 of the present invention.

FIG. 10 is a graph showing variations in firing contraction rates of the reference profile (Z1) and the alumina profile (A15) in Example 1 of the present invention.

FIG. 11 is a graph showing variations in firing contraction rates of a reference profile (Z2) and alumina profiles (A21 and A22) in Example 2 of the present invention.

FIG. 12 is an exploded perspective view of a gas sensing element manufactured in Example 3 of the present invention.

FIG. 13 is a cross sectional view of the gas sensing element shown in FIG. 12.

### DETAILED DESCRIPTION OF PREFERRED EMBODIMENTS

Now, a method of matching the firing profile of alumina material to the firing profile of dissimilar material with high precision and a method of manufacturing a ceramic stack body using such a firing profile matching method according to the present invention will be described below in detail with reference to various Examples in relation to the accompanying drawings. However, the present invention is construed not to be limited to such Examples described below and technical concepts of the present invention may be implemented in combination with other known technologies or other technologies having functions equivalent to such known technologies.

### EMBODIMENT

### Example 1

The present invention will be described below in detail with reference to Example 1.

The method of the present example is a method of matching the firing profile of alumina material, containing a principal component of alumina raw material powder to the firing profile of dissimilar material using a firing profile representing the behavior of the firing contraction rate during the firing step on the basis of the relationship between firing temperature and firing contraction rate.

With the present example, the firing profile (alumina profile) of alumina material is matched to the firing profile (reference profile) of zirconia material.

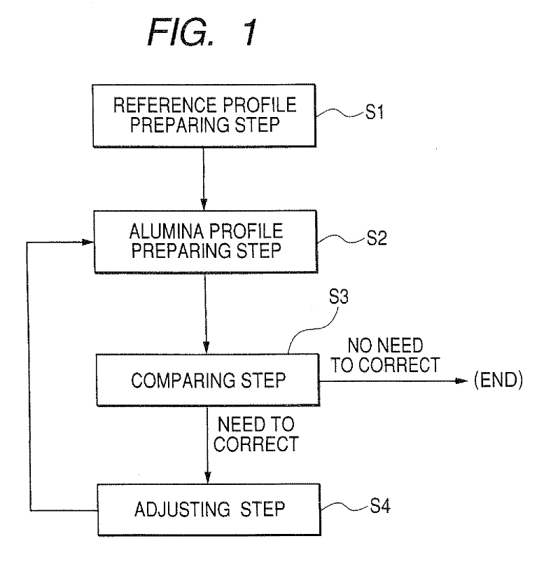

More particularly, as shown in FIG. 1, in carrying out the firing profile matching method of the present invention, a reference profile preparing step S1 and an alumina profile preparing step S2 are conducted, thereby preparing a reference profile and an alumina profile, respectively. Subsequently, in a comparing step S3, a comparison is made between the reference profile and the alumina profile to determine whether or not the alumina profile needs to be corrected. If the determination is made that the alumina profile needs to be corrected, then, an adjusting step S4 is conducted to adjust the alumina material.

After the alumina material has been adjusted, the alumina profile is prepared again (in alumina profile preparing step S2) for comparison to the reference profile (in comparing step S3). If the determination is made that the alumina profile needs to be corrected again, the alumina material is adjusted (in adjusting step S4). In such a way, the alumina profile is matched to the reference profile by repeated comparison and adjustment until satisfactory results are obtained.

With the present example, the alumina profile to be corrected is targeted at three regions including an early-stage sintering region, a middle-stage sintering region and a terminal-stage sintering region. The early-stage sintering region is a region in the vicinity of a sintering temperature ranging from 1100 to 1200° C. Further, the middle-stage sintering region is a region in the vicinity of a sintering temperature ranging from 1200 to 1400° C. In addition, the terminal-stage sintering region is a region in the vicinity of a sintering temperature ranging from 1400 to 1500° C.

Hereunder, these sintering regions will be described more in detail.

<Reference Profile Preparing Step>

First, organic substances, such as a binder, a dispersant and a plasticizer, were mixed with zirconia raw material powder having an average particle diameter of 0.5 μm with a specific surface area of 7 μm²/g, thereby preparing zirconia material z1. Also, the zirconia material z1 had an organic-substance volume ratio that was set to 36%.

Then, the zirconia material z1 was shaped using a doctor blade method, thereby preparing a zirconia ceramic sheet. The zirconia ceramic sheet was fired at a firing temperature of 1460° C. (that will be hereinafter described as “firing condition P”) to prepare a firing profile representing the relationship between the firing temperature and the firing contraction rate. The resulting firing profile is shown as “reference profile Z1” (see FIG. 2).

<Alumina Profile Preparing Step (1)>

Next, organic substances, such as a binder, a dispersant and a plasticizer, were mixed with alumina raw material powder having an average particle diameter of 0.3 μm and a specific surface area of 11 m²/g using the manufacturing method described below, thereby preparing alumina material a11. Also, an organic-substance volume ratio of the alumina material a11 was set to 37.5%.

Then, the alumina material a11 was shaped using the doctor blade method, thereby preparing an alumina ceramic sheet. The alumina ceramic sheet was fired under the firing condition P, to prepare the firing profile in FIG. 2 labelled “alumina profile A11”.

Further, the alumina raw material powder, forming a principal component of the alumina material, was produced in a manner described below.

That is, aluminum hydroxide, having an average particle diameter of 50 μm with agglutinated initial particles of 10 to 15 μm obtained by an organic aluminum hydrolysis method, was raised in temperature at a rate of 3° C./minute to a temperature of 600° C., at which a calcining step was conducted for 2 hours. By so doing, intermediate aluminum raw material powder was formed in the form of aluminum hydroxide having a large number of cracks with crystal water escaping.

Subsequently, the intermediate aluminum raw material powder was further raised in temperature to a temperature of 1100° C. and fired at such a firing temperature. During such a heating, a single crystal of α-alumina was formed with the single crystal being grown up. Then, the firing was stopped at a stage with the degree of gelatinization reaching a value of 70% or more and the single crystal grown to a size of about 0.3 μm. This results in the formation of alumina raw material powder aggregate. In this Example, the intermediate aluminum raw material powder was fired at a temperature of 1100° C. for 2 hours.

Thereafter, the alumina raw material powder aggregate was pulverized and crushed using a ball mill or a pearl mill, thereby obtaining alumina raw material powder having an average particle diameter of 0.3 μm with a specific surface area of 11 m²/g.

<Comparing Step (1)>

Next, a comparison was made between the reference profile Z1 and the alumina profile A11 in a manner as shown in FIG. 2 to determine whether to perform a correction on the alumina profile A11. As a result, the alumina profile A11 was determined to require corrections in the early-stage sintering region, the middle-stage sintering region and the terminal-stage sintering region. In the illustrated Example, the corrections were initially made in the terminal-stage sintering region.

<Adjusting Step (1)>

When correcting the alumina profile for the terminal-stage sintering region, a final firing contraction rate (final contraction rate) of alumina material was controlled. The final contraction rate depends remarkably on the volume of organic substances evaporated during the firing step. With the present Example, therefore, an organic-substance volume ratio of alumina material was selected for the purpose of controlling the final contraction rate and the alumina material was adjusted based on the selected organic-substance volume ratio.

In adjusting the alumina material, first, an effort was made to determine the relationship between the organic-substance volume ratio and the final contraction rate. More particularly, alumina ceramic sheets were prepared using varying organic-substance volume ratio of alumina material, thereby obtaining the final contraction rate with the alumina ceramic sheets fired under the firing condition P.

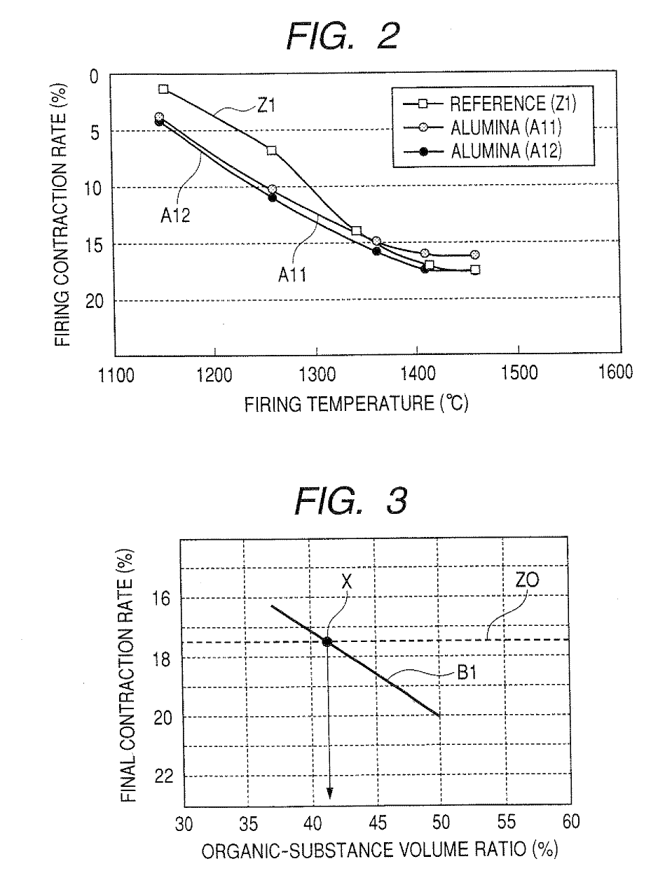

FIG. 3 represents such a result (in graph B1). From FIG. 3, it is clear that the greater the organic-substance volume ratio, the greater will be the final contraction rate.

The organic-substance volume ratio of alumina material is selected based on the result shown in FIG. 3 such that alumina material and zirconia material have the final contraction rates equal to each other. It is clear from FIG. 2 that zirconia material z1, serving as reference material, has a final contraction rate of 17.5%. Therefore, with the present Example, alumina material was selected to have an organic-substance volume ratio of 41.5% in the light of an intersecting point X between the graph B1, indicative of the final contraction rate of alumina material, and the graph Z0 representing the final contraction rate (17.5%) of zirconia material.

With such a selected organic-substance volume ratio, the alumina raw material powder was mixed with organic substances such as a binder, a dispersant and a plasticizer or the like, thereby preparing alumina material A12.

<Alumina Profile Preparing Step (2)>

Subsequently, the adjusted alumina material A12 was shaped in an alumina ceramic sheet, which in turn was fired under the firing condition P, to prepare a firing profile. The resulting firing profile was assigned to be an alumina profile A12, whose characteristics are shown in FIG. 2.

In FIG. 2, upon comparing the alumina profile A11 and the alumina profile A12 to each other, it is turned out that the alumina profile A12 is corrected so as to increase the contraction rate in the terminal-stage sintering region to be closer to that of the reference profile 71.

<Comparing Step (2)>

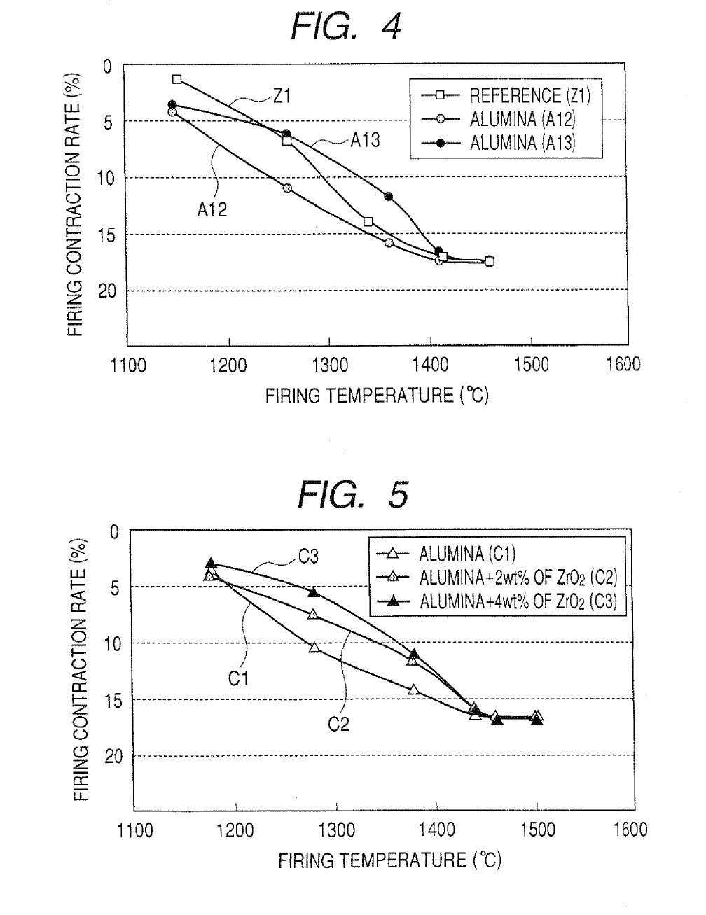

Next, a comparison was made between the reference profile Z1 and the alumina profile A12 in a manner as shown in FIG. 4 to determine whether to correct the alumina profile A12. As a result, the alumina profile A12 was determined to need correction in the early-stage sintering region and the middle-stage sintering region. In the illustrated Example, the correction for the middle-stage sintering region was performed with top priority. Then, the alumina profile A12 was further corrected in the middle-stage sintering region (in the vicinity of a temperature ranging from 1200 to 1300° C.) so as to lower the contraction rate.

<Adjusting Step (2)>

When correcting the alumina profile in the middle-stage sintering region so as to lower the contraction rate, a given amount of zirconia was added to the alumina material, thereby adjusting the alumina material. With the present Example, the amount of zirconia to be added to alumina material was chosen to adjust alumina material on the basis of the chosen amount of zirconia.

In adjusting alumina material, first, a test was conducted to check the variation in the firing profile when adding zirconia to alumina material. More particularly, alumina ceramic sheets were prepared using three kinds of alumina materials by adding 0% zirconia, 2% zirconia and 4% zirconia to 100% by weight of alumina raw material powder. The alumina ceramic sheets were fired under the firing condition P, thereby obtaining firing profiles. Also, alumina raw material powder used in such a case had an average particle diameter of 0.28 μm with a specific surface area of 11.8 m²/g. In addition, the alumina material had an organic-substance volume ratio of 41.5%.

FIG. 5 shows graphs (C1, C2 and C3) of characteristics of various test pieces. It will be apparent from these graphs that with an increase in the amount of zirconia added to alumina material, the firing profile was shifted toward a decreasing contraction rate in the middle-stage sintering region (especially in a temperature ranging from 1200 to 1300° C.). On the grounds of such a result, with the present Example, zirconia to be added to alumina material was selected to lie in an amount of 4% by weight relative to 100% by weight of alumina raw material powder.

Based on such a concept, 4% by weight of zirconia was added to alumina raw material powder, to which organic substances, such as a binder, a dispersant and plasticizer or the like, were mixed so as to achieve an organic-substance volume ratio of 41.5%, thereby preparing alumina material a13.

<Alumina Profile Preparing Step (3)>

Subsequently, the adjusted alumina material a13 was shaped in an alumina ceramic sheet, which in turn was fired under the firing condition P, thereby preparing a firing profile. The resulting firing profile was assigned to be an alumina profile A13, whose characteristics are shown in FIG. 4.

In FIG. 4, upon comparing the alumina profiles A12 and A13 to each other, it is turned out that the alumina profile A13 is corrected so as to have a lowered contraction rate in the middle-stage sintering region (especially in the vicinity of a temperature ranging from 1200 to 1300° C.) to be closer to that of the reference profile Z1.

<Comparing Step (3)>

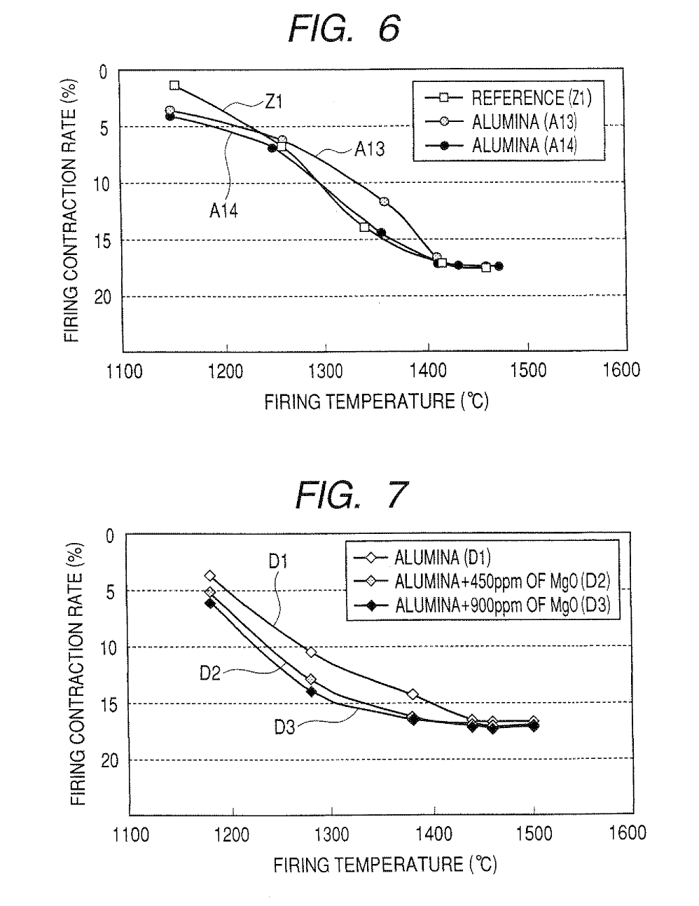

Next, a comparison was made between the reference profile Z1 and the alumina profile A13 in a manner as shown in FIG. 6 to determine whether to correct the alumina profile A13. As a result, the alumina profile A13 was determined to need corrections for the early-stage sintering region and the middle-stage sintering region. In this case, the correction for the middle-stage sintering region was performed with top priority. Then, the alumina profile A13 was first corrected in the middle-stage sintering region (in the vicinity of a temperature ranging from 1300 to 1400° C.) so as to have an increased contraction rate.

<Adjusting Step (3)>

When correcting the alumina profile in the middle-stage sintering region so as to have an increased contraction rate, a given amount of magnesia was added to alumina material, thereby adjusting the alumina material. With the present Example, the amount of magnesia to be added to alumina material was chosen to adjust alumina material on the basis of the chosen amount of added magnesia.

In adjusting alumina material, first, a test was conducted to check the variation in the firing profile with magnesia being added to alumina material. More particularly, alumina ceramic sheets were prepared using three kinds of alumina materials by adding in amounts of 0 ppm of magnesia, 450 ppm of magnesia and 900 ppm of magnesia to 100% by weight of alumina raw material powder. The alumina ceramic sheets were fired under the firing condition P to obtain firing profiles. Also, alumina raw material powder used in such a case had an average particle diameter of 0.28 μm with a specific surface area of 11.8 m²/g. In addition alumina material had an organic-substance volume ratio of 41.5%.

FIG. 7 shows graphs (D1, D2 and D3) plotted on characteristics of various test pieces in the absence or presence of magnesia. It will be apparent from these graphs that with an increase in the amount of magnesia added to alumina material, the firing profile was shifted toward an increasing contraction rate in the middle-stage sintering region (especially in a temperature ranging from 1300 to 1400° C.). From this result, in the present Example, the amount of magnesia to be added to alumina material was selected to be 450 ppm on the basis of 100% by weight of alumina raw material powder.

Based on such a concept, 450 ppm of magnesia and 2% by weight of zirconia were added to alumina raw material powder, to which organic substances, such as a binder, a dispersant and plasticizer or the like, were mixed so as to achieve an organic-substance volume ratio of 41.5%, thereby preparing alumina material a14.

<Alumina Profile Preparing Step (4)>

Subsequently, the adjusted alumina material A14 was shaped into an alumina ceramic sheet, which in turn was fired under the firing condition P to prepare a firing profile. The resulting firing profile was assigned to be an alumina profile A14, whose characteristics are shown in FIG. 6.

In FIG. 6, upon comparing the alumina profile A13 and the alumina profile A14 to each other, it can be seen that the alumina profile A14 is corrected so as to have an increased contraction rate in the middle-stage sintering region (especially in the vicinity of temperatures ranging from 1300 to 1400° C.) to be closer to that of the reference profile Z1.

<Comparing Step (4)>

Next, a comparison was made between the reference profile Z1, shown in FIG. 6, and the alumina profile A14 to determine whether any correction is needed of the alumina profile A14. As a result, the alumina profile A14 was determined to need correction in the early-stage sintering region. The alumina profile A14 was corrected in the early-stage sintering region so as to have a lowered contraction rate.

<Adjusting Step (4)>

When correcting the alumina profile in the early-stage sintering region so as to have a lowered contraction rate, alumina material was adjusted by decreasing a specific surface area of alumina raw material powder serving as a principal component of alumina material. With the present Example, the specific surface area of alumina raw material powder was selected and the alumina material was adjusted by using the alumina raw material powder with selected specific surface area.

In adjusting alumina material, first, a test was conducted to check the variation in the firing profile with magnesia being added to alumina material. More particularly, alumina ceramic sheets were prepared using four kinds of alumina materials having specific surface areas of 8.2 m²/g, 9.5 m²/g, 11.8 m²/g and 12.1 m²/g, after which firing profiles were obtained with the alumina ceramic sheets being fired under the firing condition P. In addition, alumina material had an organic-substance volume ratio of 40%. Further, alumina raw material powders with the specific surface areas were prepared by varying firing temperatures of intermediate alumina raw material powders and pulverizing time intervals of alumina raw material powder aggregates during production of alumina raw material powders.

FIG. 9 shows graphs (E1, E2, E3 and E4) plotted of characteristics of various test pieces with different specific surface areas of alumina raw material powders. It will be apparent from these graphs that with a decrease in specific surface areas of alumina raw material powder, the firing profile was shifted toward a decreasing contraction rate in the early-stage sintering region. From this result, with the present example, the specific surface area of alumina raw material powder was altered from 11.8 m²/g to 11 m²/g.

Based on such an altered specific surface area, 450 ppm of magnesia and 2% by weight of zirconia were added to alumina raw material powder with the specific surface area of 11 m²/g, to which organic substances, such as a binder, a dispersant and plasticizer or the like, were mixed so as to achieve an organic-substance volume ratio of 41.5%, thereby preparing alumina material A15.

<Alumina Profile Preparing Step (5)>

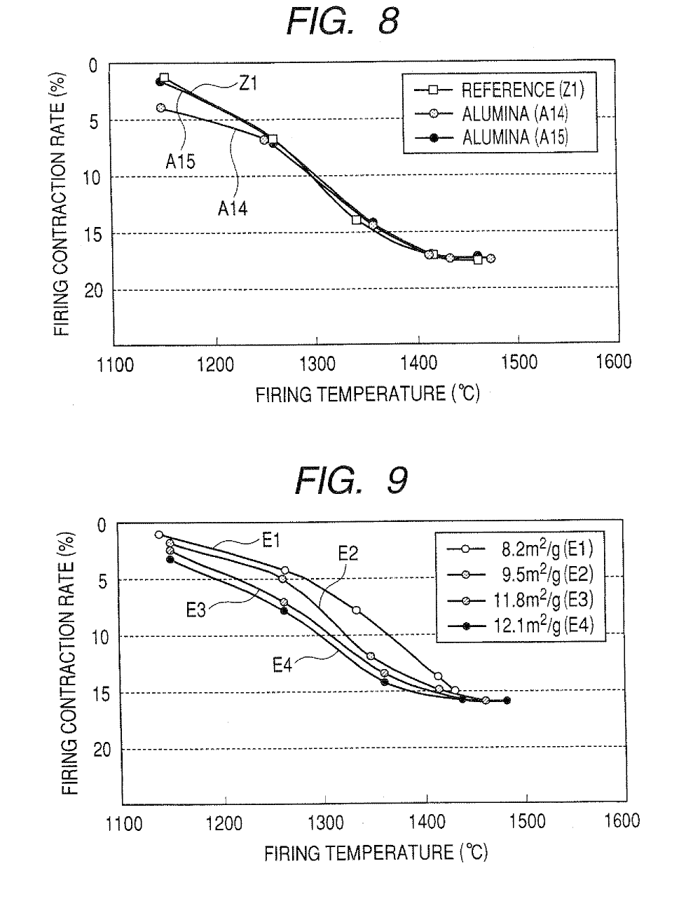

Subsequently, adjusted alumina material A15 was made into an alumina ceramic sheet, which in turn was fired under the firing condition P, thereby preparing a firing profile. The resulting firing profile was assigned to be an alumina profile A15, whose characteristics are shown in FIG. 8.

In FIG. 8, upon comparing the alumina profiles A14 and A15 to each other, it is found that the alumina profile A15 is corrected so as to achieve a lowered contraction rate in the early-stage sintering region to be closer to that of the reference profile Z1.

<Comparing Step (5)>

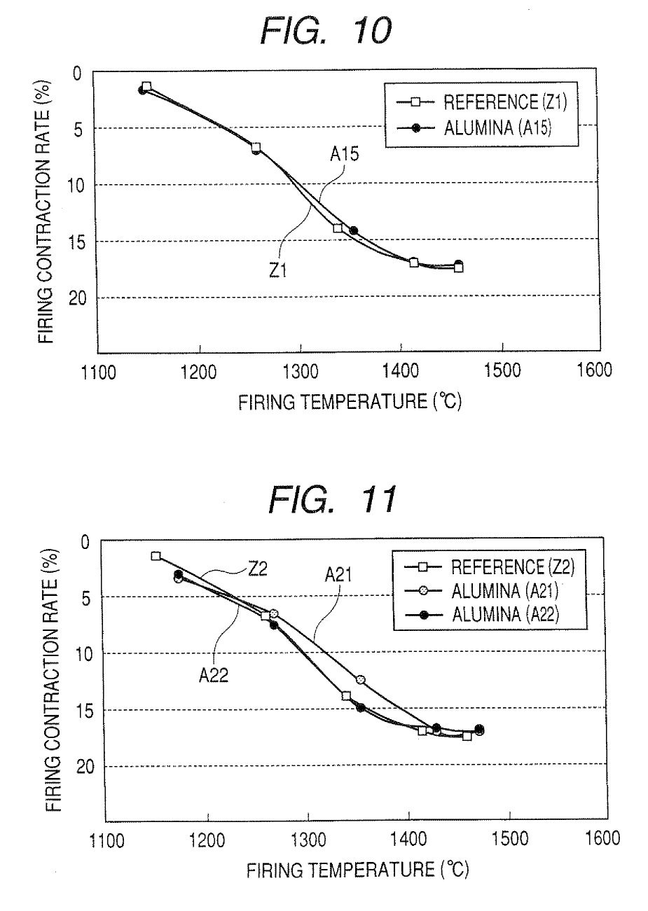

Next, a comparison was made between the reference profile Z1, shown in FIG. 10, and the alumina profile A15 to determine whether to correct the alumina profile A15. The reference profile Z1 and the alumina profile A15 had firing contraction rates nearly equal to each other in behavior and the alumina profile A15 was determined not to need further correction.

With the above, the adjustments of the firing profiles of alumina materials were terminated.

Hereunder, advantageous effects of the method of matching the firing profile of alumina material will be described in detail.

With the present Example, when adjusting the alumina profile in the early-stage sintering region, the adjusting step S4 was conducted to adjust alumina material upon increasing or decreasing the specific surface area of alumina raw material powder. This enables alumina material to be sintered (or contracted) at an accelerated or retarded rate in the early-stage sintering region. In addition, this allows the alumina profile to be corrected to achieve a decreased or increased contraction rate.

When correcting the alumina profile to lower the contraction rate in the middle-stage sintering region, further, zirconia is added to alumina material. This gives a capability of retarding the sintering (contracting) of alumina material in the middle-stage sintering region (especially at temperatures ranging from 1200 to 1300° C.) while correcting the alumina profile to lower the contraction rate.

When correcting the alumina profile to increase the contraction rate in the middle-stage sintering region, furthermore, magnesia is added to alumina material. This enables alumina material to be sintered at an accelerated rate in the middle-stage sintering region while causing the alumina material to be corrected to increase the contraction rate.

When correcting the alumina profile in the terminal-stage sintering region, moreover, the organic-substance volume ratio of alumina material is varied. This enables a final contraction ratio of alumina material to be controlled in the terminal-stage sintering region while causing alumina material to increase or lower the contraction rate.

With such an arrangement, the present Example enables the alumina profile to be finely controlled in the early-stage sintering region, the middle-stage sintering region and the final-stage sintering region. Therefore, the alumina profile can be easily matched to the reference profile with high precision. That is, it becomes possible to each match the firing profile of alumina material to the firing profile of different kinds of materials with high precision.

With the present example, after conducting the reference profile preparing step S1, the following three steps (the alumina profile preparing step S2, the comparing step S3 and the adjusting step S4) are repeatedly conducted until the determination is made in the comparing step S3 that no further correction is needed. Therefore, it becomes possible to match the firing profile of alumina material to the firing profiles of different materials with further increased precision.

### Example 2

This example represents a case in which the firing profile (alumina profile) of alumina material is matched to the firing profile (reference profile) of zirconia material. In addition, the alumina profile is matched to the reference profile with only a correction executed on the alumina profile in the middle-stage sintering region so as to increase the contraction rate.

In this Example 2, the basic steps were conducted using the same steps as those of Example 1 (see FIG. 1).

Now, Example 2 will be described below in detail.

<Reference Profile Preparing Step>

First, organic substances such as a binder, a dispersant and a plasticizer or the like, were mixed into a zirconia raw material having an average particle diameter of 0.5 μm with specific surface area of 7 m²/g, thereby preparing zirconia material Z2. Also, the organic-substance volume ratio of the zirconia material Z2 was set to 36%.

Then, the zirconia material Z2 was shaped using a doctor blade method, thereby preparing a zirconia ceramic sheet. The zirconia ceramic sheet was fired under the firing condition P″ to prepare a firing profile representing the relationship between a firing temperature and the firing contraction rate. The resulting firing profile is reference profile Z2 (see FIG. 11).

<Alumina Profile Preparing Step (1)>

Next, organic substances, such as a binder, a dispersant and a plasticizer, were mixed with an alumina raw material powder, obtained by Bayer's process, which has an average particle diameter of 0.24 μm with a specific surface area 12.1 m²/g, thereby preparing an alumina material A21. Also, the organic-substance volume ratio of the alumina material A21 was set to a value of 45%.

<Comparing Step (1)>

Next, a comparison was made between the reference profile Z2 and an alumina profile A21 in a manner as shown in FIG. 11 to determine whether to correct the alumina profile A21. As a result, the alumina profile A21 was determined to need correction in the middle-stage sintering region (especially at a temperature in the vicinity of a value ranging from 1300 to 1400° C.) so as to increase the contraction rate.

<Adjusting Step (1)>

When correcting the alumina profile in the middle-stage sintering region so as to increase the contraction rate, a given amount of magnesia was added to alumina material, thereby adjusting alumina material. As a result of a variation in the firing profile with magnesia being added to the alumina material as shown in FIG. 7, in this Example, the amount of magnesia to be added to the alumina material was selected to be 200 ppm.

On the ground of such selection, 200 ppm of magnesia was added to an alumina raw material powder, to which organic-substances such as a binder, a dispersant and plasticizer or the like were mixed so as to have an organic-substance volume ratio of 45%, thereby preparing an alumina material A22.

<Alumina Profile Preparing Step (2)>

Subsequently, the adjusted alumina material A22 was shaped into an alumina ceramic sheet A22, which in turn was fired under the firing condition P to prepare a firing profile. The resulting firing profile was assigned to be an alumina profile A22, whose characteristics are shown in FIG. 11. It will be apparent from FIG. 11 that the reference profile Z2 and the alumina profile A22 have firing contraction rate closer to each other in the middle-stage sintering region (especially at a temperature in the vicinity of a value ranging from 1300 to 1400° C.).

<Comparing Step (2)>

Next, a comparison was made between the reference profile Z2 and the alumina profile A22 in a manner as shown in FIG. 11 to determine whether to correct the alumina profile A22. As a result of such a comparison, it was determined that the reference profile Z2 and the alumina profile A22 had almost identical firing contraction rates with no need for correcting the alumina profile A22.

With the above, the adjustment on the firing profile of the alumina material was completed.

### Example 3

This example is directed to a case wherein a method of matching the firing profile of alumina material according to the present invention is applied to a method of manufacturing a gas sensing element incorporated in an oxygen sensor mounted on an exhaust pipe of a vehicular internal combustion engine such as, for instance, an automotive engine for measuring the oxygen concentration in exhaust gases.

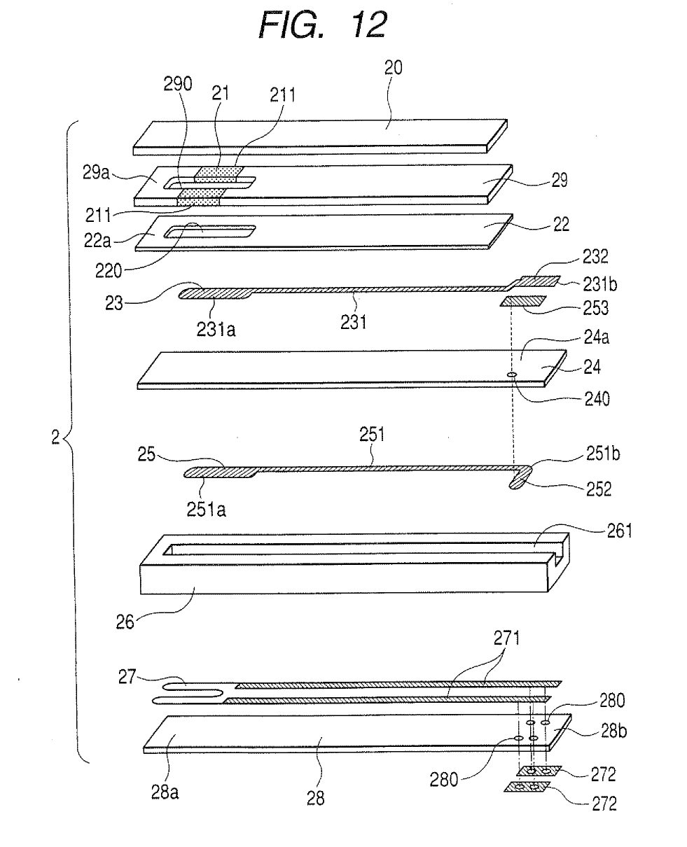

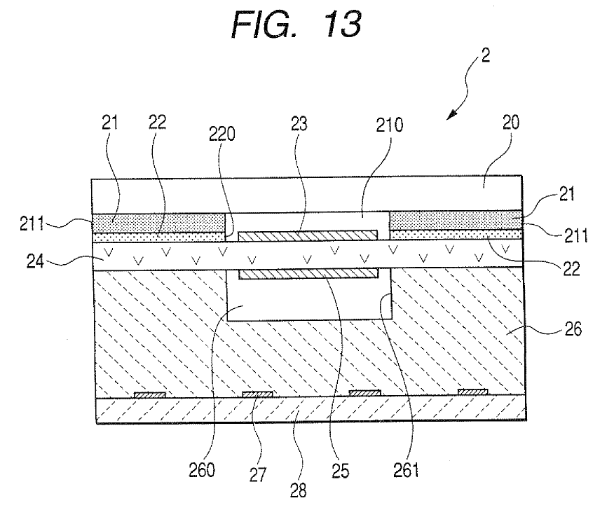

As shown in FIGS. 12 and 13, a gas sensing element 2 of this Example 3 includes a solid electrolyte body 24, made of zirconia having an oxygen ion conductivity, on one surface of which is laminated an insulating layer 22, made of gas-impermeable dense alumina and having a base end 22a formed with an elongated opening portion 220. Sandwiched between the solid electrolyte body 24 and the insulating layer 22 is an electrode lead portion 231 made of platinum and having a base end 231a formed with a longitudinally extending gas measuring electrode 23 and a leading end 231b formed with a longitudinally extending terminal segment 232 with a terminal segment 253 intervening between the electrode terminal segment and the solid electrolyte body 24.

As shown in FIG. 12, further, a measuring gas chamber forming layer 29 is laminated on the solid electrolyte body 24. The measuring gas chamber forming layer 29 is made of alumina, being electrically insulating, and dense not to allow gas to permeate. The measuring gas chamber forming layer 29 has a base end 29a formed with an elongated opening portion 290 in vertical alignment with the elongated opening portion 220 of the insulating layer 22 to define a gas measuring chamber 210 (see FIG. 13).

Further, a shielding layer 20, made of dense material such as alumina with increased gas shielding properties, is laminated on the measuring gas chamber forming layer 29.

Furthermore, the measuring gas chamber forming layer 29 and the shielding layer 20 are stacked on the solid electrolyte body 24 in such a way to cover the electrode lead portion 231 having the gas measuring electrode 23 exposed to the gas measuring chamber 210. This allows the electrode lead portion 231 to be covered with the shielding layer 20 and the measuring gas chamber forming layer 29 which are made of dense ceramics.

As shown in FIGS. 12 and 13, furthermore, the measuring gas chamber forming layer 29 has a pair of porous diffusion resistance layers 21 embedded in the base end 29a so as to partly define the opening portion 290. In particular, the porous diffusion resistance layers 21 has end faces 211, each exposed to a plane intersecting an axis of the gas sensing element 2, which extends parallel to each other so as to sandwich the opening portion 290. Thus, the end faces 211, exposed to both sides of the gas sensing element 2, allow measuring gases to permeate so as to allow the same to pass through the porous diffusion resistance layer 21 to be admitted to the gas measuring chamber 210.

As shown in FIG. 12, further, the solid electrolyte body 24 has the other surface provided with an electrode lead portion 251 made of platinum and having a base end 251a formed with a longitudinally extending reference gas electrode 25 and a leading end 251b formed with a laterally extending terminal segment 252. In addition, the terminal segment 252 is electrically connected to the terminal segment 253 via a conducting element passing through a through-hole 240 formed in the solid electrolyte body 24 at a leading end 24a thereof.

As shown in FIGS. 12 and 13, furthermore, a reference gas chamber forming layer 26, made of gas-impermeable dense alumina, is stacked on the other surface of the solid electrolyte layer 24. The reference gas chamber forming layer 26 has one surface formed with a longitudinally extending recessed portion 261 acting as a reference gas chamber 260. The reference gas chamber 260 takes the form of a structure that admits a gas such as, for instance, atmospheric air as a reference gas.

As shown in FIGS. 12 and 13, moreover, the reference gas chamber forming layer 26 has the other surface on which a heater substrate 28, made of alumina, is stacked. The heater substrate has one surface formed with a heating element 27 on a base end 28a. The heating element 27 is connected to longitudinally extending lead portions 271 formed on one surface of the heater substrate 28 in face-to-face relation with the reference gas chamber forming layer 26 to be conductive when supplied with electric power from an external power supply (not shown). The heater substrate 28 has a leading end 28b and a pair of terminal portions 272 is formed on the other side of the heater substrate 28 at the leading end 28b thereof. The terminal portions 272 are electrically connected to the lead portions 271 of the heater element 27 via conductors extending through through-holes 280 formed in the heater substrate 28 at the leading end 28b thereof.

Thus, the gas sensing element 2 is comprised of a ceramic stack body including a stack of the shielding layer 20 made of alumina, the measuring gas chamber forming layer 29 having the porous diffusion resistance layer 21, the insulating layer 22, the reference gas chamber forming layer 26, the heater substrate 28 and the solid electrolyte body 24 made of zirconia.

In manufacturing the gas sensing element 2 composed of such a ceramic stack body, the method of matching the firing profile of alumina material according to the present invention is implemented so as to match firing profiles of alumina materials forming the shielding layer 20, the measuring gas chamber forming layer 29, the insulating layer 22 and the heater substrate 28 to firing profiles of zirconia material forming material of the solid electrolyte body 24 (in firing profile adjusting step).

Subsequently, a plurality of alumina ceramic sheets, forming the shielding layer 20, the measuring gas chamber forming layer 29, the insulating layer 22 and the reference gas chamber forming layer 26 and the heater substrate 28, and a zirconia ceramic sheet forming the solid electrolyte body 24 are prepared by a doctor blade method using the alumina materials and the zirconia material with the firing profiles matched to each other.

Thereafter, the plural alumina ceramic sheets and the zirconia ceramic sheet are stacked on each other in a given layout (see FIGS. 12 and 13) into a unitary structure, which is fired to prepare a ceramic stack body (in firing step).

The resulting ceramic stack body, obtained in such a way discussed above, is treated as the gas sensing element 2.

In such a case, the plural alumina ceramic sheets and the zirconia ceramic sheet, obtained in the sheet preparing step, are prepared in structures with the firing profiles of respective sheets becoming closer to each other. In the firing step, therefore, if a stack of the plural alumina ceramic sheets and the zirconia ceramic sheet is fired in a unitary structure, the firing profiles of both sheets become closer to each other. This prevents the ceramic sheets from warping during the firing step while suppressing the occurrence of defects such as flaking or cracks. Accordingly, the resulting ceramic stack body can have a dimension with high precision with increased quality.

While the specific Examples of the present invention have been described in detail, it will be appreciated by those skilled in the art that various modifications and alternatives to those details could be developed in light of the overall teachings of the disclosure. Accordingly, the particular arrangements disclosed are meant to be illustrative only and not limited to the scope of the present invention, which is to be given the full breadth of the following claims and all equivalents thereof.

What is claimed is:

1. A method of adjusting a firing profile of alumina material for matching the firing profile of alumina material to a firing profile of dissimilar material upon using a firing profile representing the behavior of the firing contraction rate in a firing step by referring to the relationship between a firing temperature and the firing contraction rate, the method comprising:
a reference profile preparing step of preparing a reference profile representing the firing profile of the dissimilar material occurring when the dissimilar material is fired under a specified firing condition;
an alumina profile preparing step of preparing an alumina profile representing the firing profile of the alumina material occurring when the alumina material is fired under the specified firing condition;
a comparing step of making a comparison between the reference profile and the alumina profile for determining whether to correct the alumina profile so as to lower the contraction rate in an early-stage sintering region or whether to or not to correct the alumina profile so as to increase the contraction rate in the early-stage sintering region; and
an adjusting step of adjusting the alumina material by increasing the specific surface area of the alumina raw material powder when a determination is made in the comparing step that the alumina profile needs to be corrected while lowering the specific surface area of the alumina raw material powder when correcting the alumina profile so as to increase the contraction rate in the early-stage sintering region.

2. The method of adjusting the firing profile of alumina material according to claim 1, wherein:
the alumina raw material powder is manufactured by preparing an intermediate alumina raw material powder upon calcining aluminum hydroxide resulting from Bayer's method or an organic aluminum hydrolysis method, firing the intermediate alumina raw material powder so as to accelerate grain growth in alpha phase to prepare an alumina raw material powder aggregate, and subsequently pulverizing the alumina raw material aggregate.

3. The method of adjusting the firing profile of alumina material according to claim 2, wherein.
in the adjusting step, a specific surface area of the alumina raw material powder depends on the firing temperature of the intermediate alumina raw material powder or/and pulverizing time interval of the alumina raw material powder aggregate during production of the alumina raw material powder.

4. A method of adjusting firing profile of alumina material for matching the firing profile of alumina material to a firing profile of dissimilar material upon using a firing profile representing a behavior of a firing contraction rate in a firing step by referring to the relationship between a firing temperature and the firing contraction rate, the method comprising:
a reference profile preparing step of preparing a reference profile representing the firing profile of the dissimilar material occurring when the dissimilar material is fired under a specified firing condition;
an alumina profile preparing step of preparing an alumina profile representing the firing profile of the alumina material occurring when the alumina material is fired under the specified firing condition;
a comparing step of making a comparison between the reference profile and the alumina profile for determining whether to or not to correct the alumina profile so as to lower the contraction rate in a middle-stage sintering region; and
an adjusting step of adjusting the alumina material by adding zirconia to the alumina material when a determination is made in the comparing step that the alumina profile needs to be corrected so as to lower the contraction rate in the middle-stage sintering region.

5. The method of adjusting the firing profile of alumina material according to claim 4, wherein:
in the adjusting step, the amount of zirconia to be added to the alumina material is selected to lie in a value of 6% by weight or less on the basis of 100% by weight of the alumina raw material powder.

6. A method of adjusting the firing profile of alumina material for matching the firing profile of alumina material to the firing profile of dissimilar material upon using a firing profile representing behavior of the firing contraction rate in the firing step by referring to the relationship between firing temperature and firing contraction rate, the method comprising:
a reference profile preparing step of preparing a reference profile representing the firing profile of the dissimilar material occurring when the dissimilar material is fired under a specified firing condition;
an alumina profile preparing step of preparing an alumina profile representing the firing profile of the alumina material occurring when the alumina material is fired under the specified firing condition;
a comparing step of making a comparison between the reference profile and the alumina profile for determining whether to or not to correct the alumina profile so as to increase the contraction rate in the early-stage sintering region; and
an adjusting step of adjusting the alumina material by adding magnesia to the alumina material when a determination is made in the comparing step that the alumina profile needs to be corrected so as to increase the contraction rate in the middle-stage sintering region.

7. The method of adjusting the firing profile of alumina material according to claim 4, wherein:
in the adjusting step, the amount of magnesia to be added to the alumina material is selected to lie in a value of 1000 ppm or less relative to the alumina raw material powder.

8. A method of adjusting the firing profile of alumina material for matching the firing profile of alumina material to a firing profile of dissimilar material upon using a firing profile representing the behavior of the firing contraction rate in the firing step by referring to the relationship between firing temperature and firing contraction rate, the method comprising:
a reference profile preparing step of preparing a reference profile representing the firing profile of the dissimilar material occurring when the dissimilar material is fired under a specified firing condition;
an alumina profile preparing step of preparing an alumina profile representing the firing profile of the alumina material occurring when the alumina material is fired under the specified firing condition;
a comparing step of making a comparison between the reference profile and the alumina profile for determining whether to or not to correct the alumina profile so as to decrease or increase the contraction rate in an early-stage sintering region; and
an adjusting step of adjusting the alumina material by increasing the specific surface area of the alumina raw material powder when a determination is made in the comparing step that the alumina profile needs to be corrected so as to lower the contraction rate in the early-stage sintering region and adding magnesia to the alumina material when a determination is made in the comparing step that the alumina profile needs to be corrected so as to increase the contraction rate in the middle-stage sintering region.

9. The method of adjusting the firing profile of alumina material according to claim 8, wherein:
when the determinations are made in the comparing step that the alumina profile needs to be corrected in both of the early-stage sintering region and the middle-stage sintering region, a correction for the middle-stage sintering region is executed with priority.

10. The method of adjusting the firing profile of alumina material according to claim 8, wherein:
when the determinations are made in the comparing step that the alumina profile needs to be corrected in both of the early-stage sintering region and the middle-stage sintering region, a correction for the early-stage sintering region is executed with priority.

11. The method of adjusting the firing profile of alumina material according to claim 8, wherein:
the alumina raw material powder is manufactured by preparing an intermediate alumina raw material powder upon calcining aluminum hydroxide resulting from a Bayer's method or an organic aluminum hydrolysis method, firing the intermediate alumina raw material powder so as to accelerate grain growth in the alpha phase to prepare an alumina raw material powder aggregate, and subsequently pulverizing the alumina raw material aggregate.

12. The method of adjusting the firing profile of alumina material according to claim 11, wherein:
in the adjusting step, a specific surface area of the alumina raw material powder depends on the firing temperature of the intermediate alumina raw material powder or/and pulverizing time interval of the alumina raw material powder aggregate during production of the alumina raw material powder.

13. The method of adjusting the firing profile of alumina material according to claim 8, wherein:
in the adjusting step, the amount of zirconia to be added to the alumina material is selected to lie in a value of 6% by weight or less relative to 100% by weight of the alumina raw material powder.

14. The method of adjusting the firing profile of alumina material according to claim 8, wherein:
in the adjusting step, the amount of magnesia to be added to the alumina material is selected to lie in a value of 1000 ppm or less relative to the alumina raw material powder.

15. The method of adjusting the firing profile of alumina material according to claim 1, wherein:
the reference profile preparing step is conducted after which the alumina profile preparing step, the comparing step and the adjusting step are repeatedly conducted until a determination is made in the comparing step that no need arises to correct the alumina material.

16. A method of manufacturing a ceramic stack body having alumina ceramic sheets, made of alumina material having a principal component of alumina raw material powder, and dissimilar ceramic sheets made of dissimilar material, which are stacked and fired in a unitary structure, the method comprising:
a firing profile adjusting step of matching the firing profile of the alumina material to the firing profile of the dissimilar material using the method of adjusting the firing profile of alumina material according to claim 1;
a sheet preparing step of shaping the alumina material to prepare the alumina ceramic sheets and shaping the dissimilar material to prepare the dissimilar ceramic sheets; and
a firing step of stacking the alumina ceramic sheets and the dissimilar ceramic sheets into the unitary structure and subsequently firing the unitary structure to prepare the ceramic stack body.

17. The method of manufacturing the ceramic stack body according to claim 16, wherein:
the ceramic stack body is used as a gas sensing element.

18. A ceramic stack body manufactured by the method of manufacturing the ceramic stack body according to claim 16.
